(19) United States
(12) Patent Application Publication
(10) Pub. No.: US 2015/0144781 A1
(43) Pub. Date: May 28, 2015

(54) METHOD AND APPARATUS FOR CONTROLLING THE SUPPLY OF IONS

(71) Applicant: Micromass UK Limited, Wilmslow (GB)

(72) Inventors: Kevin R. Howes, Altrincham (GB); Simon Meffan-Main, Manchester (GB); Richard B. Moulds, Cheshire (GB)

(73) Assignee: Micromass UK Limited, Wilmslow (GB)

(21) Appl. No.: 14/409,735

(22) PCT Filed: Jun. 17, 2013
(86) PCT No.: PCT/GB2013/051575

§ 371 Date: Dec. 19, 2014

(30) Foreign Application Priority Data
Jun. 22, 2012 (GB) 1211048.2

(51) Int. Cl. H01J 49/10; H01J 49/00; H01J 49/04

(52) U.S. Cl. CPC H01J 49/10; H01J 49/0431; H01J 49/0031
USPC 250/282; 250/288

(57) ABSTRACT

A method for controlling the supply of ions from a liquid chromatograph through an ion source into a mass spectrometer. The ion source is foreseen to be either an electrospray ionization sources or an impaction spraying ion sources. The ion source can be operated in two modes: a mode in which ions are supplied into the mass spectrometer and a mode in which ions are prevented to be supplied into the mass spectrometer. In this latter mode, the supply of ions into the mass spectrometer is prevented by reducing the potential applied to the ionization source, reducing the nebulizer gas flow and/or increasing the cone gas flow.

This invention relates generally to ion sources and their methods of operation. More specifically, although not exclusively, the invention relates to electrospray ion sources for use in Mass Spectrometers where the ion source inlet is connected to a chromatography column.

Ion sources for Mass Spectrometers (MS) can be adapted to receive solvents and samples that are eluted from Chromatography systems. The sources are made of particular materials, and designed in particular geometries in order to optimize the efficiency of ionisation and consequently, optimize the transmission of the ions through the ion source and into the mass analysers of the instrument. However, in the early stages of a Liquid Chromatography (LC) experiment, salts, buffers and other potential contaminants may be dissolved in the solvent eluting from the LC, which may be harmful to the efficiency of the ion source, and potentially damaging to the performance of other parts of the Mass Spectrometer if they pass through the ion source into the vacuum chamber.

Currently, this issue is generally solved by having a valve in between the LC and MS source, so that unwanted eluant from the LC system does not enter the ion source of the MS, instead the eluant passes to waste. However, the valves are costly, and stopping the flow of the eluant through the connective tubing may potentially lead to blockages in the tubing and ion source inlet system. Furthermore, an in-line valve may also cause dispersion, increasing the peak width, and so compromise the LC's ability to separate samples.

Therefore, it is a non-exclusive object of the invention to provide an improved method of control of the supply of ions, and an improved ion source for use in an LC-MS instrument and more specifically to provide an alternative method of regulating the flow of ions from the ion source into the MS vacuum assembly that overcomes or at least mitigates the problems associated with the prior art methods and systems.

According to a first aspect of the invention, a method for controlling the supply of ions from a Liquid Chromatograph (LC) through an ion source and into a Mass Spectrometer (MS) is provided. The method comprises the steps of operating the ion source in a first mode where eluant produced in the LC passes through a probe into a source volume but is prevented from entering an inlet of the MS in an ionized form, changing one or more operating parameters of the ion source and operating the ion source in a second mode where at least some ions are produced in said ion source and pass through said MS inlet into the MS.

It would be appreciated that the method may comprise changing the one or more operating parameters to switch the ion source from the first mode to the second mode and/or from the second mode to the first mode.

In a preferred embodiment, a first voltage is applied to the ion source probe in the first mode, and a second voltage is applied to the ion source probe in the second mode, wherein the second voltage may be higher than the first voltage. Preferably the first voltage is between 0 and 0.5 kV, more preferably between 0 and 0.2 kV, most preferably substantially equal to zero. Preferably, the second voltage is between 0.5 and 7 kV, more preferably between 1 and 5 kV and most preferably between 2 and 4 kV.

In one embodiment of the present invention, a first nebulizer gas flow is emitted (applied) at the exit of the probe in the first mode and a second nebulizer gas flow is emitted (applied) at the exit of the probe in the second mode, wherein the second nebuliser gas flow may be greater than the first nebuliser gas flow. Preferably the first nebulizer gas flow is between 0 and 10 L/hr, but most preferably substantially equal to zero. Preferably, the second nebulizer gas flow is between 50 and 500 L/hr, more preferably between 70 and 300 L/hr and most preferably between 100 and 200 L/hr.

In another embodiment of the invention, a first cone gas flow is directed (applied) along the sampling cone in the first mode and a second cone gas flow is directed (applied) along the sampling cone in the second mode, wherein the second cone gas flow may be less than the first cone gas flow. Preferably, the first cone gas flow is between 100 and 1200 L/hr, more preferably between 100 and 600 L/hr and most preferably between 250 and 500 L/hr. Preferably, the second cone gas flow is between 0 and 200 L/hr, but most preferably between 0 and 100 L/hr.

In one embodiment of the invention, the step of changing one or more operating parameters is performed (e.g. changing from the first mode to the second mode) when compounds of interest are present or detected in the eluant produced in said LC.

In a preferred embodiment of the invention, the ion source is operated in the first mode upon the start of a LC run and in the second mode upon elution of compounds of interest from said LC.

In the preferred embodiment, the method includes providing an ion source, for example that is adapted and arranged to perform the method.

In a further aspect of the invention an ion source for use between a Liquid Chromatograph (LC) and a Mass Spectrometer (MS) is provided, preferably configured for use in performing the above method. The ion source comprises a sample inlet for receiving eluant from a LC, a probe in fluidic communication with the sample inlet, an ion outlet in communication with or corresponding to an inlet of a MS and a source volume between the sample inlet and the ion outlet, wherein the ion source is operable, in use, between a first mode in which eluant received from the LC passes through the probe into the source volume but is substantially prevented from entering an inlet of the MS in an ionized form and a second mode in which ions are produced in the ion source and pass through the ion outlet and into the MS.

In one embodiment of the invention the ion source is an electrospray ion source.

In a further embodiment of the invention, the ion source is an impaction spraying ion source.

In this embodiment, preferably, in the second mode of operation, a voltage may be applied to an impact surface, preferably the impact surface of a pin. In a less preferred embodiment, no voltage may be applied to the surface, and ionisation may still occur, however ionisation may be less efficient.

In this embodiment, preferably, in the first mode of operation there is no nebuliser gas flow around the ion source probe.

In this embodiment, preferably, in the first mode of operation, the eluant may miss the surface, and pass to the base of the ion source, to be collected in a drain.

In a less preferred aspect of this embodiment, the LC eluant may drop onto the surface. In this instance, very little, or no ionisation will occur.

In this embodiment, preferably, the voltage applied to the surface may be switched off.

In this embodiment, preferably, in first mode of operation, the desolvation gas flow, arranged to flow from a heater positioned around the ion source probe to allow desolvation of the droplets, may be switched off.

In this embodiment, in the first mode of operation, the cone gas flow directed along the sampling cone, into the ionization volume, is preferably increased in strength to ensure that substantially none of the LC eluant not of interest to the user can pass through the sample cone into the instrument in the first mode.

In a preferred embodiment the ion source further comprises a drain for removing LC eluant, which has not been ionized and passed through the ion inlet, from the source volume.

In a further aspect, a Mass Spectrometer comprising an ion source as described is provided.

In a further aspect, a Liquid Chromatograph in combination with a Mass Spectrometer and an ion source is provided.

In one aspect, a control system operable or programmed to execute a method as described herein is provided.

One aspect of the invention provides a computer program element comprising computer readable program code means for causing a processor to execute a procedure to implement the method described herein.

In a further aspect, a computer program element is provided comprising computer readable program code means for causing a processor to execute a method as described herein.

A further aspect provides a computer readable medium embodying the computer program element described herein.

One aspect provides a computer readable medium having a program stored thereon, where the program is to make a computer execute a procedure to implement the method as described herein.

Embodiments of the invention will now be described by way of example only with reference to the accompanying drawings in which:

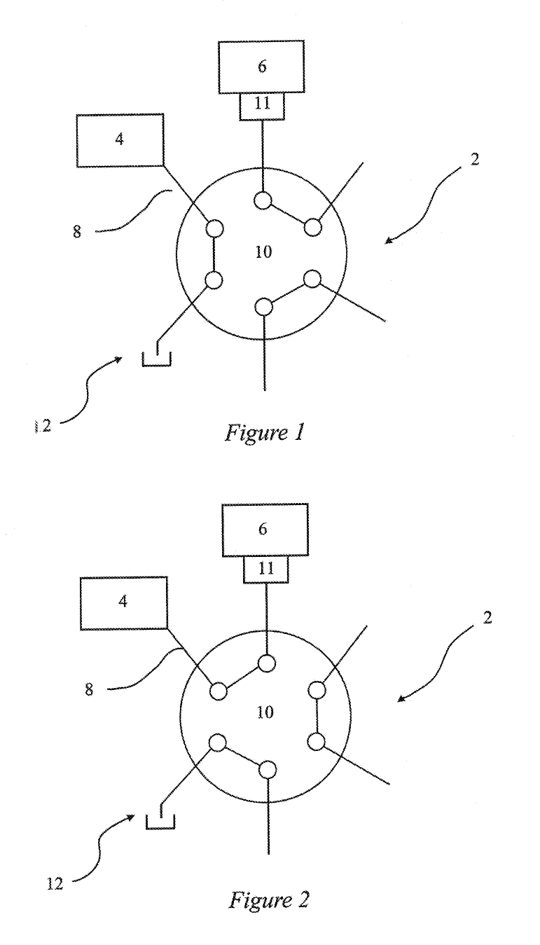

FIG. 1 is a schematic illustration of a prior art apparatus operating in a first mode;

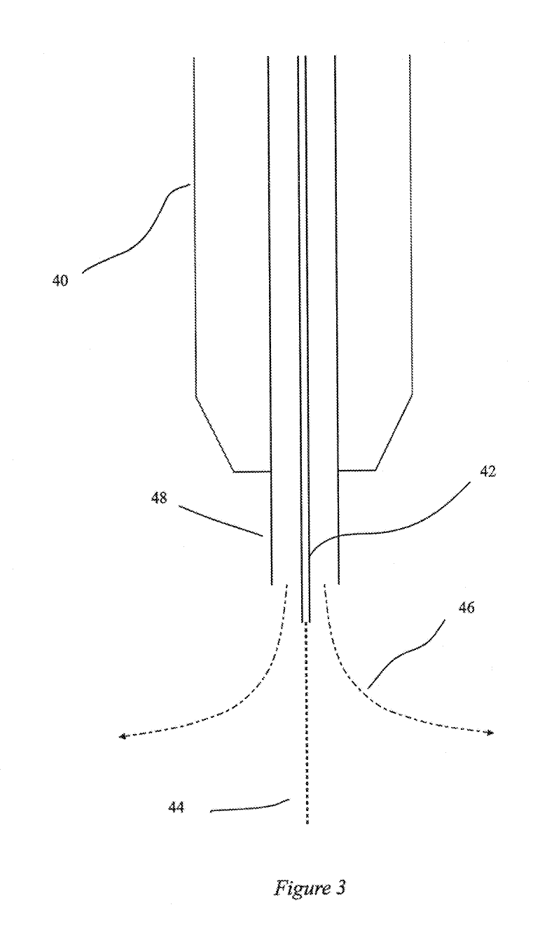

FIG. 2 is a schematic illustration of the prior art apparatus of FIG. 1 operating in a second mode;

FIG. 3 is an illustration of an ion source probe suitable for use with the present invention;

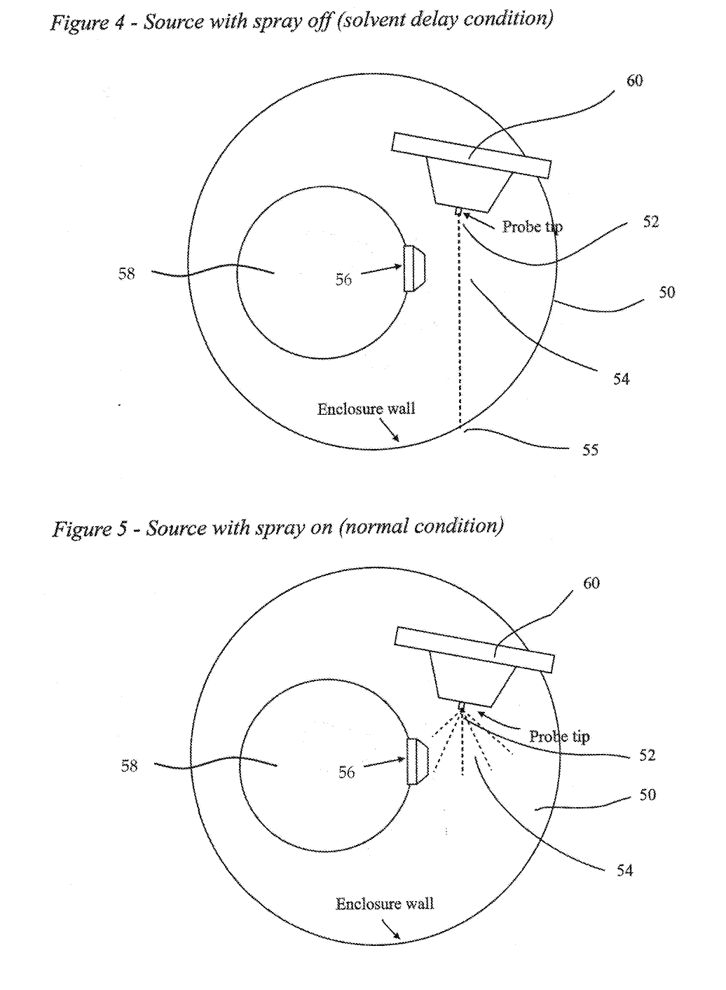

FIG. 4 is an illustration of an apparatus embodying the present invention operating in a first mode;

FIG. 5 is an illustration of an apparatus embodying the present invention operating in a second mode;

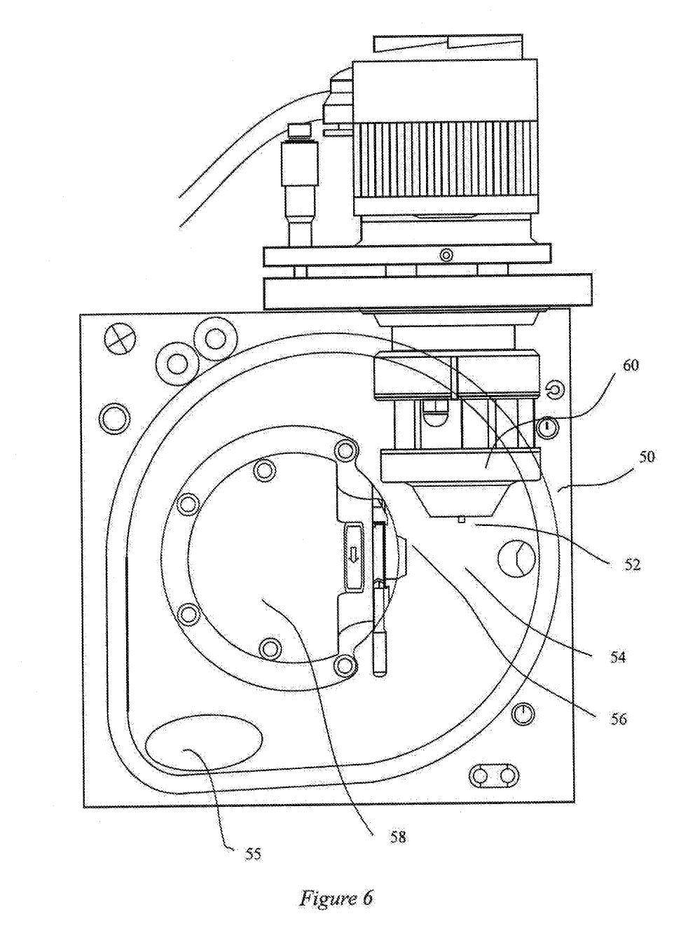

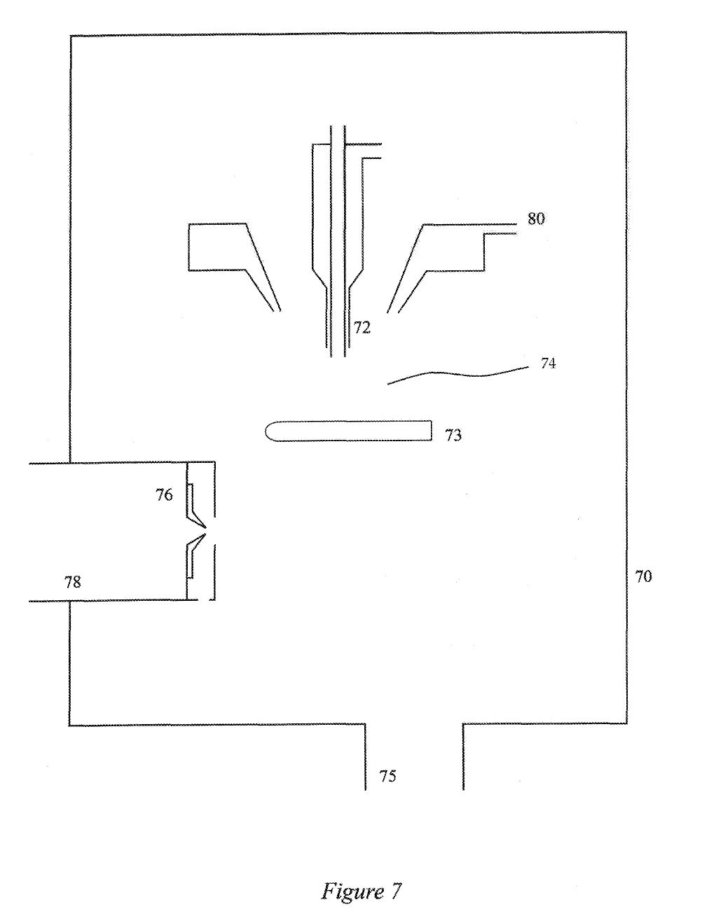

FIG. 6 is an illustration of an ion source arranged to perform the invention; and

FIG. 7 is an illustration of an impaction spraying ion source suitable for use with the present invention.

Turning to FIG. 1, a first mode of the prior art apparatus is schematically illustrated. The apparatus 2 comprises a Liquid Chromatograph 4, and a Mass Spectrometer 6. The Liquid Chromatograph has an LC outlet 8 from which LC eluant emerges during a chromatography run. The LC outlet 8 is connected to a two-position, six-port valve 10. In a first position, the valve 10 is arranged to connect the LC outlet to waste 12. In this instance, the LC eluant from the Liquid Chromatograph, is therefore valved to waste, so that the LC eluant will not pass it into the Mass Spectrometer's ion source 11.

FIG. 2 schematically illustrates the prior art apparatus of FIG. 1 operating in a second mode. In the second mode, the valve 10 is in the second position. In the second position, the valve 10 is arranged to connect the LC outlet to an ion source 11 (rather than to waste 12 as shown in FIG. 1). The Ion source assembly 11 is arranged to receive the LC eluant from the Liquid Chromatograph, and pass it into the Mass Spectrometer's ion source 11.

FIG. 3 shows an electrospray probe tip that may be used with the present invention. In this Figure, the LC eluant from the Liquid Chromatography system is provided to the ion source probe 40 through the LC outlet (not shown) from the Liquid Chromatograph. In use, in the second mode, a voltage is applied to the capillary tube 42. A LC eluant passing through the capillary tube 42, will gain charge from the ion source probe, and pass into the ionization volume 44. In order to assist this process a nebuliser gas flow shown by arrows 46 flows into the ionization chamber. The nebuliser tube 48 emits a gas that assists the spraying of the LC eluant into the ionisation chamber.

FIG. 4 shows an ion source according to one embodiment of the invention in a first mode wherein the LC eluant from the Liquid Chromatograph is not of interest to the user. The apparatus shows an ion source 50 having an ion source probe 52 which is connected to the LC outlet from the Liquid Chromatograph (not shown). In contrast to the mode illustrated in FIG. 3, no voltage is applied to the capillary tube (not shown), within the ion source probe 52. Additionally, the nebuliser gas flow (not shown) is switched off. Accordingly, the LC eluant does not spray out of the ion source probe when it passes through the ion source probe 52 into the ionization volume 54. Instead, the LC eluant will pass through the probe tip and drops out into the ionization volume. Additionally, no ions will be formed as there is no nebuliser gas flow or voltage applied to the ion source probe. The non-ionized LC eluant will pass from the ion source probe, and fall to the base of the ionization source, under gravity, where it can be collected by a drain 55 at the base of the ionization volume.

The desolvation gas flow, arranged to flow from a heater 60 positioned around the ion source probe 52 to allow desolvation of the droplets, optionally could be switched off.

In the most preferred embodiment, in the first mode, the cone gas flow directed along the sampling cone 56, into the ionization volume 54 would be increased in strength to ensure that none of the LC eluant not of interest to the user can pass through the sample cone into the instrument.

FIG. 5 shows the ion source of FIG. 4 in a second mode wherein the LC eluant from the Liquid Chromatograph is of interest to the user. The apparatus shows an ion source 50 having an ion source probe 52 which is connected to the LC outlet from the Liquid Chromatograph (not shown). The ion source probe is preferably arranged as in FIG. 3 where a voltage is applied to the capillary tube (not shown), within the ion source probe 52. Additionally, a nebuliser gas flow (not shown) assists the LC eluant passing through the ion source probe to spray out of the ion source probe 52 into the ionization volume 54. The combination of the nebuliser gas flow and the voltage applied to the ion source probe results in the spraying of LC eluant, and formation of ions within the ionization volume. Ions then pass through the ionization volume and are directed through the sample cone 56, and into the vacuum chamber 58 of the Mass Spectrometer (not shown). The ions can then be analyzed by the Mass Spectrometer to provide data relating to the ionized LC eluant.

A desolvation gas flow is arranged to flow from a heater 60 which is positioned around the ion source probe 52 and the gas flow is heated by the heater 60 to aid desolvation of the droplets of solvent within the spray. A cone gas flow is directed along the sampling cone 56, into the ionization volume 54 which aids desolvation and reduces surface contamination of the sampling cone 56.

FIG. 6 shows a source in accordance with one embodiment of the invention. In this embodiment the ion source 50, has an ion source probe 52, which is connected to the eluant from a liquid Chromatography column. At the start of a Chromatography run, salts, buffers and other potential contaminants may be dissolved in the solvent eluting from the column, and the sample of interest may not be eluting. At this time, the ion source may be configured to operate in the first mode as described with relation to FIG. 4, where no voltage is applied to the capillary tube (not shown) within the ion source probe 52. Additionally, the nebuliser gas flow (not shown) is switched off. Accordingly, the LC eluant does not spray out of the ion source probe 52 when it passes through the ion source probe 52 into the ionization volume 54. Instead the LC eluant will pass through the probe tip and drops out into the ionization volume. Additionally, no ions will be formed as there is no nebuliser gas flow or voltage applied to the ion source probe. The non-ionized LC eluant will pass from the ion source probe, and fall to the base of the ionization source, where it can be collected by a drain 55 at the base of the ionization volume.

The desolvation gas flow, arranged to flow from a heater 60 positioned around the ion source probe 52 to allow desolvation of the droplets optionally could be switched off.

In the most preferred embodiment, the cone gas flow directed along the sampling cone 56, into the ionization volume 54 would be increased in strength to ensure that none of the LC eluant not of interest to the user can pass through the sample cone 56 into the instrument in the first mode.

After a time, the elution of solvent with salts, buffers and other potential contaminants from the LC column may have stopped (or at least reduced to below an acceptable threshold). At a time when the solvent may contain sample of interest, the ion source 50 is preferably configured to operate in the second mode, as described with relation to FIG. 5, where a voltage is applied to the capillary tube (not shown), within the ion source probe 52. Additionally, a nebuliser gas flow (not shown) assists the LC eluant passing through the ion source probe 52 to spray out of the ion source probe 52 into the ionization volume 54. The combination of the nebuliser gas flow and the voltage applied to the ion source probe 52 result in the spraying of LC eluant, and formation of ions within the ionization volume 54. Ions then pass through the ionization volume 54 and are directed through the sample cone 56, and into the vacuum chamber 58 of the Mass Spectrometer (not shown). The ions can then be analyzed by the Mass Spectrometer to provide data relating to the ionized LC eluant.

A desolvation gas flow is arranged to flow from a heater 60 which is positioned around the ion source probe 52 and the gas flow is heated by the heater 60 to aid desolvation of the droplets of solvent within the spray. A cone gas flow is directed along the sampling cone 56, into the ionization volume 54 which aids desolvation and reduces surface contamination of the sampling cone 56.

In some embodiments of the invention, the voltage applied to the ion source probe 52 is set to zero in the first mode. This would prevent ionization of the sample.

In some embodiments of the invention the nebuliser gas flow is set to zero in the first mode, which would prevent a spray from forming from the ion source probe 52 as sample flows through the ion source probe 52.

In some embodiments of the invention, the cone gas flow may be increased in the first mode relative to the second mode to prevent sample emitted from the ion source probe 52 to be allowed through the sample cone 56 and into the Mass Spectrometer.

Additionally, or alternatively, any combination of the above features, and/or embodiments of the invention may be used to prevent sample from ionizing and entering the vacuum chamber of the Mass Spectrometer.

In a most preferred embodiment, in the first mode, the voltage applied to the ion source probe 52 is set to zero and, the nebuliser gas flow is set to zero, which would prevent a spray from forming from the ion source probe 52 as sample flows from the ion source probe 52. Furthermore, in the first mode the cone gas flow may be increased to prevent sample emitted from the ion source probe 52 to be allowed through the sample cone 56 and into the Mass Spectrometer.

Table 1 gives most preferred, and possible ranges of values for the capillary voltage, the nebulizer gas flow rate, and cone gas flow rate in both the first and the second modes according to the invention.

TABLE 1

| | First mode | | | Second mode | | |
|---|---|---|---|---|---|---|
| | Most | | | Most | | |
| | preferred | Preferred | Possible | preferred | Preferred | Possible |
| Capillary | 0 | 0 to 0.2 | 0 to 0.5 | 2 to 4 | 1 to 5 | 0.5 to 7 |
| voltage (kV) | | | | | | |
| Nebulizer gas | 0 | 0 to 10 | 0 to 20 | 100 to 200 | 70 to 300 | 50 to 500 |
| flow rate (L/hr) | | | | | | |
| Cone gas flow | 250 to 500 | 100 to 600 | 100 to 1200 | 0 to 100 | 0 to 200 | 0 to 900 |
| rate (L/hr) | | | | | | |

It would be apparent to a person skilled in the art that the source apparatus could be switched between the first mode and the second mode automatically by the control apparatus of the LCMS system at pre-determined times within the LCMS run. In a less preferred embodiment, a user could control the switching between modes.

In an alternative embodiment of the invention, a further detector may be used to identify and automatically detect the point at which samples of interest start to elute from the LCMS instrument in order to guarantee that no useful LC eluant from the Liquid Chromatography system is lost. This may take the form of, for example, a UV, or IR spectrometer.

In a further embodiment the ion source 50 may be switched from the second, ionization enabled mode to said first, non-ionizing, mode at known retention times when any unwanted ions may be known, or anticipated, to be eluting from the sample.

FIG. 7 shows a further embodiment where an impaction spraying ion source is provided. Similar to electrospray, this type of source is capable of being used in accordance with the invention. When in operation and creating ions (in the second mode of operation) the apparatus shows an ion source 70 having an ion source probe 72 which is connected to the LC outlet from the Liquid Chromatograph (not shown). Unlike in electrospray, no voltage is applied to the capillary tube 71 (not shown), within the ion source probe 72. A nebuliser gas flow (not shown) is provided at the probe tip. A surface 73 is placed in the path of the flow of eluant within the ionisation volume 74, and preferably a voltage is applied to the surface. The nebuliser gas flow (not shown) converts the LC eluant passing through the ion source probe 72 into a droplet stream, which then sprays into the ionization volume 74. The spray impacts upon the surface 73 resulting in the formation of ions within the ionization volume 74. Ions then pass through the ionization volume 74 and are directed through the sample cone 76, and into the vacuum chamber 78 of the Mass Spectrometer (not shown). The ions can then be analyzed by the Mass Spectrometer to provide data relating to the ionized LC eluant.

In the second mode of operation, no voltage may be applied to the surface 73, and ionisation may still occur, however ionisation may be less efficient.

In the first mode of operation, where no ions are formed, there is no nebuliser gas flow around the ion source probe 72. The LC eluant will not spray from the ion source probe 72.

In one embodiment, the LC eluant may drop onto the surface 73 (as might occur with the arrangement shown in FIG. 7). In this instance, very little, or no ionisation will occur.

In another, preferred, embodiment, in the first mode of operation, the eluant may miss the surface 73, and pass to the base of the ion source, to be collected in a drain 75.

In one embodiment in this first mode of operation, the voltage upon the surface 73 may be switched off.

In a further embodiment of this first mode of operation, the desolvation gas flow, arranged to flow from a heater 80 positioned around the ion source probe 72 to allow desolvation of the droplets could be switched off.

In a further embodiment of this first mode of operation, the cone gas flow directed along the sampling cone 76, into the ionization volume 74 would be increased in strength to ensure that none of the LC eluant not of interest to the user can pass through the sample cone into the instrument in the first mode.

A method of analysis of a sample is also envisaged, where a sample is injected into a Liquid Chromatography system. Initially, the ion source 50 (or 70) will be set in a first mode, such that no ions are formed, and LC eluant is not passed through the sample cone 56, and into the Mass Spectrometer's analysis system. This prevents salts, impurities and other contaminants from entering the Mass Spectrometer's vacuum systems, so that they do not impair the results of the instrument due to contaminating the sample cone 56 (or 76), or the internal workings of the Mass Spectrometer's ion optical devices. In one embodiment, a solvent delay time is set by the user, this period should be long enough to allow the LC eluant that may contaminate the sample to pass through the LC and MS systems, but short enough so that the first eluted samples have not passed through the instrument.

Once the solvent delay time has expired, the ion source 50 (or 70) is switched to the second, ionization enabled mode where the voltage within the ion source 50 (or 70), the nebuliser gas flow and the cone gas flow can be set to provide ionization, so that ions will enter the Mass Spectrometer through the sample cone 56 (or 76) for analysis.

In a preferred embodiment in the second mode, the voltage on the ion source probe 52, the nebuliser gas flow and the cone gas flow optimized to allow as high ionization efficiency as possible.

It will be appreciated by those skilled in the art that any number of combinations of the aforementioned features and/or those shown in the appended drawings provide clear advantages over the prior art and are therefore within the scope of the invention described herein.

Any ranges quoted herein are inclusive.

1. A method for controlling the supply of ions from a Liquid Chromatograph (LC) through an ion source and into a Mass Spectrometer (MS) comprising the steps of:—
A) operating the ion source in a first mode in which eluant produced in the LC passes through a probe into a source volume but is prevented from entering an inlet of the MS in an ionized form;
B) selectively changing one or more operating parameters of the ion source to operate the ion source in a second mode in which at least some ions are produced in said ion source and pass through said MS inlet into the MS.

2. A method as described in claim 1 wherein a first voltage is applied to said ion source probe in said first mode, and a second voltage is applied to said ion source probe in said second mode, said second voltage being higher than said first voltage.

3. A method as described in claim 1, wherein the first voltage is substantially equal to zero.

4. A method as described in claim 1, wherein a first nebulizer gas flow is emitted at the exit of the probe in said first mode and a second nebulizer gas flow is emitted at the exit of the probe in said second mode, said second nebuliser gas flow being greater than said first nebuliser gas flow.

5. A method as described in claim 4, wherein the first nebulizer gas flow is substantially equal to zero.

6. A method as described in claim 1, wherein a first cone gas flow is applied in said first mode and a second cone gas flow is applied in said second mode, said second cone gas flow being less than said first cone gas flow.

7. A method as described in claim 1, wherein said step of changing one or more operating parameters is performed when compounds of interest are present or detected in said eluant produced in said LC.

8. A method as described in claim 1, wherein said ion source is arranged to operate in said first mode upon the start of a LC run and in the second mode upon elution of compounds of interest from said LC.

9. (canceled)

10. (canceled)

11. An ion source for use between a Liquid Chromatograph (LC) and a Mass Spectrometer (MS), the ion source comprising a sample inlet for receiving eluant from a LC, a probe in fluidic communication with the sample inlet, an ion outlet in communication with or corresponding to an inlet of a MS and a source volume between said sample inlet and said ion outlet, characterised in that said ion source is selectively operable, in use, between a first mode in which eluant received from the LC passes through said probe into the source volume but is substantially prevented from entering an inlet of the MS in an ionized form and a second mode in which ions are produced in said ion source and pass through said ion outlet and into the MS.

12. An ion source as described in or claim 11, wherein said ion source is an electrospray ion source.

13. An ion source as described in claim 11, wherein said ion source is an impaction spraying ion source.

14. An ion source as described in claim 11, wherein said ion source further comprises a drain for removing LC eluant.

15-21. (canceled)
